(19) United States
(12) Patent Application Publication
(10) Pub. No.: US 2015/0207183 A1
(43) Pub. Date: Jul. 23, 2015

(54) LITHIUM SECONDARY BATTERY

(71) Applicant: TOYOTA JIDOSHA KABUSHIKI KAISHA, Toyota-shi (JP)

(72) Inventor: Machiko ABE, Okazaki-shi (JP)

(73) Assignee: TOYOTA JIDOSHA KABUSHIKI KAISHA, Toyota-shi (JP)

(21) Appl. No.: 14/601,704

(22) Filed: Jan. 21, 2015

(30) Foreign Application Priority Data
Jan. 23, 2014 (JP) 2014-010824

(51) Int. Cl. H01M 10/42; H01M 2/34; H01M 10/0567; H01M 10/052; H01M 10/0587

(52) U.S. Cl. CPC H01M 10/4235; H01M 10/052; H01M 10/0587; H01M 10/0567; H01M 2/345; H01M 2300/0025; H01M 2200/20

(57) ABSTRACT

A lithium secondary battery is provided, which exhibits a large overcharge tolerance even after rapid charge-discharge cycling. The lithium secondary battery is constituted by a battery case hosing electrode assembly having a positive electrode and a negative electrode, and also housing a nonaqueous electrolyte solution including a supporting salt. The nonaqueous electrolyte solution contains, in addition to the supporting salt, at least 2 wt % of a gas-forming agent that decomposes to form a gas when the battery reaches an overcharged state and, as a surfactant, at least 1 wt % of a polyethylene glycol fatty acid ester. The battery case is equipped with a current interrupt device that is actuated by a rise in pressure within the battery case.

### BACKGROUND OF THE INVENTION

1. Field of the Invention

The invention relates to a lithium secondary battery. More specifically, the invention relates to a lithium secondary battery having a pressure-actuated current interrupt device.

This application claims priority from Japanese Patent Application No. 2014-010824 filed on Jan. 23, 2014, the entire contents of which are incorporated herein by reference.

2. Description of the Related Art

Compared with preexisting batteries, lithium secondary batteries are lightweight and have a high energy density. For these reasons, they are favored for use as power sources for propelling vehicles such as electric cars and hybrid cars, and as so-called portable power sources for personal computers and handheld devices.

Such batteries are generally used in a state where the voltage has been regulated so as to stay within a predetermined range (e.g., from 3.0 to 4.1 V). However, there are cases where, due to incorrect operation, for example, a higher than normal current is supplied to the battery, causing it to exceed the predetermined voltage and become overcharged. When such overcharging occurs, problems sometimes ensue, such as the evolution of gases due to decomposition of the nonaqueous electrolyte solution or a rise in temperature at the battery interior due to heating of the active material.

Solutions to the above have hitherto been proposed. For example, Japanese Patent Application No. 2003-297423 describes art in which an aromatic compound having an oxidation potential higher than the battery cutoff voltage is added to the nonaqueous electrolyte solution. When the battery reaches an overcharged state, a high-resistance film is formed on the surface of the active material by means of an oxidation polymerization of the aromatic compound. According to this Japanese Patent Application No. 2003-297423, the resulting film suppresses the overcharging current and is able to stop overcharging from proceeding any further.

Also, in high-capacity type batteries designed for use as power sources for vehicle propulsion, for example, one common solution is to provide a pressure-actuated current interrupt device (CID) in the battery case and also include within the nonaqueous electrolyte solution a compound that decomposes and forms a gas when the battery has become overcharged (this compound is typically an aromatic compound, and is also referred to below as a “gas-forming agent”). When the battery reaches an overcharged state, the gas-forming agent oxidatively decomposes at the surface of the positive electrode, generating hydrogen ions, which leads to the formation of hydrogen gas (H₂) at the negative electrode. This gas causes the pressure within the battery case to rise rapidly. As a result, the current interrupt device can be actuated at the initial stage of overcharging, making it possible to achieve a battery having a high reliability (overcharge tolerance).

### CITATION LIST

### Patent Literature

Patent Document 1: JP 2003-297423 A

Patent Document 2: JP 2012-190569 A

Patent Document 3: WO 2008/078626 A

### SUMMARY OF THE INVENTION

However, according to our investigations, in conventional batteries equipped with a current interrupt device, following rapid charge-discharge cycling at a high rate of 2 C or more (especially 5 C or more), the reactivity of the gas-forming agent during overcharging declines, as a result of which the amount of gas decreases or gas formation becomes gradual. Such a tendency was found to become especially pronounced in high-energy density batteries having a large-width electrode assembly such as a wound electrode assembly.

Accordingly, the object of this invention is to provide a lithium secondary battery which is equipped with a current interrupt device actuated by a rise in the battery internal pressure (pressure-actuated CID) and has a large overcharge tolerance even after rapid charge-discharge cycling.

The inventors have conducted repeated investigations from various angles on the cause of the decline in the reactivity of the gas-forming agent in a battery following rapid charge-discharge cycling. As a result, they found that the distribution (lack of uniformity in the presence) of gas-forming agent within the electrode assembly exerts an influence.

That is, the edge portions of the electrode assembly have more opportunities to come into contact with the nonaqueous electrolyte solution than the center portion, and so the storing and releasing of the supporting salt (specifically, the charge carrier ions) is carried out more actively at the edge portions during charging and discharging. On account of this, following rapid charge-discharge cycling, the concentration of the supporting salt (specifically, the charge carrier ions) at the center portion of the electrode assembly becomes relatively high compared with the concentration at the edge portions of the electrode assembly. In other words, a lack of uniformity in the supporting salt concentration arises within the electrode assembly. Consequently, given that the polarity becomes higher toward the center portion of the electrode assembly where the supporting salt concentration is high, the nonaqueous electrolyte solution and the (typically nonpolar) gas-forming agent undergo phase separation at the center portion. Moreover, the presence (i.e., dissolution) of the gas-forming agent at the center portion of the electrode assembly becomes more difficult.

Therefore, contrary to the concentration profile of the supporting salt, the amount of gas-forming agent present (the amount dissolved) becomes smaller toward the center portion of the electrode assembly and becomes larger toward the edge portions of the electrode assembly. As a result, at the center portion of the electrode assembly, the amount of gas-forming agent is small and so the decomposition reaction for this gas-forming agent does not readily arise. On the other hand, at the edge portions of the electrode assembly, the supporting salt concentration is low and so the flow of current worsens, making it difficult for the potential to rise. This in turn discourages the gas-forming agent decomposing reaction from arising.

The decrease in the reactivity of the gas-forming agent during overcharging in a battery after rapid charge-discharge cycling is believed to be accounted for by this sort of mechanism.

In light of the above, the inventors thought of keeping the amount of gas-forming agent present (the amount dissolved) within the electrode assembly uniform, even in cases where a lack of uniformity in the supporting salt concentration arises within the electrode assembly as a result of rapid charge-discharge cycling. After conducting intensive investigations, they ultimately arrived at the present invention.

Accordingly, this invention provides a lithium secondary battery having a battery case housing an electrode assembly having a positive electrode and a negative electrode, and also housing a nonaqueous electrolyte solution including a supporting salt. The nonaqueous electrolyte solution contains, in addition to the supporting salt, at least 2 wt % of a gas-forming agent that decomposes to form a gas when the battery reaches an overcharged state and, as a surfactant, at least 1 wt % of a polyethylene glycol fatty acid ester. The battery case is equipped with a current interrupt device that is actuated by a rise in pressure within the battery case (pressure-actuated CID).

By including a polyethylene glycol fatty acid ester in the nonaqueous electrolyte solution, phase separation between the nonaqueous electrolyte solution and the gas-forming agent at the center of the electrolyte assembly can be suppressed. This enables the gas-forming agent to be uniformly distributed within the positive electrode (specifically, within the positive electrode active material layer). As a result, even after rapid charge-discharge cycling, it is possible for the gas-forming agent at the center portion of the electrode assembly to quickly oxidatively decompose when overcharging occurs. Moreover, by including the above-indicated amount of gas-forming agent in the nonaqueous electrolyte solution, a large amount of gas can be more quickly generated when overcharging occurs. Therefore, the art disclosed herein enables the overcharge tolerance (reliability) to be enhanced relative to the existing art.

In addition, Japanese Patent Application No. 2012-190569 and WO 2008/078626 disclose art in which a surfactant is included in a nonaqueous electrolyte solution for the purpose of improving the load characteristics, etc. However, no mention or suggestion whatsoever is made concerning either the problems or the actions and effects described above in connection with this invention.

In a preferred embodiment of the lithium secondary battery disclosed herein, the content of the polyethylene glycol fatty acid ester is not more than 3 wt %. By setting the amount of surfactant within this range, the battery resistance (e.g., the initial IV resistance) can be kept low. This makes it possible to achieve both a high level of overcharge tolerance and also excellent battery characteristics (such as energy density or power density) during normal use.

In another preferred embodiment of the lithium secondary battery disclosed herein, the content of the gas-forming agent is not more than 5 wt %. By setting the amount of gas-forming agent within this range, the battery resistance (e.g., the initial IV resistance) can be kept low. This too makes it possible to achieve both a high level of overcharge tolerance and excellent battery characteristics (such as energy density or power density) during normal use.

From the standpoint of such considerations as solubility in the nonaqueous electrolyte solution and availability, advantageous use can be made of polyethylene glycol distearate as the polyethylene glycol fatty acid ester.

In yet another preferred embodiment of the lithium secondary battery disclosed herein, the electrode assembly is a wound electrode assembly made up of a positive electrode, a negative electrode and a separator, each having an elongated shape, that have been placed over one another and wound together in a lengthwise direction thereof. In a width direction defined as the direction along a winding axis of the wound electrode assembly from a first edge portion of the wound electrode assembly toward a second edge portion thereof, the ratio Mb/Ma of the amount (Mb) of the gas-forming agent included at an edge portion of the positive electrode to the amount (Ma) of the gas-forming agent included at a center portion of the positive electrode is less than 2. Moreover, in the width direction, the ratio Qb/Qa of the amount per unit volume (Qb) of the supporting salt included at an edge portion of the negative electrode to the amount per unit volume (Qa) of the supporting salt included at a center portion of the negative electrode is 2 or more.

According to investigations by the inventors, in a wound electrode assembly, owing to the large size of the electrodes, a lack of uniformity in the presence of the gas-forming agent tends to arise readily in the direction of impregnation by the nonaqueous electrolyte solution (e.g., the width direction). Because batteries equipped with a wound electrode assembly generally have a high energy density, solutions taken when overcharging occurs are especially important. The application of this invention is particularly effective in this connection.

As used herein, “center portion” refers to a region that includes the center in a linear direction from a first edge in the width direction of the wound electrode assembly to a second edge thereof. Letting the full length in the linear direction be 100%, the center portion typically refers to the region that can be represented as the center ±15% (such as ±10%, and especially ±5%). Also, “edge portion” refers to a region that includes an edge in a linear direction from the first edge in the width direction of the wound electrode assembly to the second edge thereof. Letting the full length in the linear direction be 100%, this typically refers to each of the two regions that extend 30% (such as 10%, and especially 5%) from the two edges.

Qualitative and quantitative determinations of the gas-forming agent included in the positive electrode (typically, the positive electrode active material layer) can be carried out using, for example, ordinary gas chromatography (GC).

First, the battery is disassembled and the positive electrode (positive electrode active material layer) is removed and lightly washed with a suitable solvent, following which specimens of predetermined sizes are cut out from, respectively, the edge portions and the center portion in the direction of impregnation (width direction) by the nonaqueous electrolyte solution. Next, the specimens are immersed for a given length of time (e.g., about 1 to 30 minutes) in a suitable solvent (e.g., hexane), thereby extracting the gas-forming agent ingredient to be measured (typically an aromatic compound). By subjecting the resulting solution to GC analysis, the type and amount of gas-forming agent can be confirmed. Next, the amount of gas-forming agent present per unit volume is typically determined by dividing the above measured values by the surface area of the positive electrode active material layer furnished for measurement. The Mb/Ma ratio can then be calculated by comparing the results obtained for the edge portions with the results obtained for the center portion.

Qualitative and quantitative determinations of the supporting salt included per unit volume of the negative electrode (typically, the negative electrode active material layer) can be carried out using, for example, ordinary nuclear magnetic resonance (NMR).

First, the battery is disassembled and the negative electrode (negative electrode active material layer) is removed and lightly washed with a suitable solvent, following which specimens of predetermined sizes are cut out from, respectively, the edge portions and the center portion in the direction of impregnation (width direction) by the nonaqueous electrolyte solution. Next, the specimens are immersed for a given length of time (e.g., about 1 to 30 minutes) in a suitable solvent (e.g., d-tetrahydrofuran (D-THF)), thereby extracting into the solvent the supporting salt ingredient to be measured (typically an anion, such as PF₆⁻). By subjecting the resulting solution to NMR analysis, the type and amount of supporting salt can be confirmed. Next, the amount of supporting salt present per unit volume is determined by dividing the above measured values by the volume of the negative electrode active material layer furnished for measurement. The Qb/Qa ratio can then be calculated by comparing the results obtained for the edge portions with the results obtained for the center portion.

The lithium secondary battery disclosed herein is characterized by fully exhibiting the advantageous effects of gas-forming agent addition and thus having an excellent overcharge tolerance even after rapid charge-discharge cycling. In a preferred embodiment, the invention is characterized by being able to achieve both excellent battery characteristics during normal use and an excellent overcharge tolerance. Accordingly, by making the most of these characteristics, the inventive battery can be suitably used in applications that require the battery to have a high overcharge tolerance, a high energy density and a high power density. One such application is as a high-energy power source for vehicle propulsion. According to another aspect disclosed herein, the invention provides a vehicle equipped with the lithium secondary battery of the invention. The battery mounted in the vehicle may be in the form of a battery pack in which a plurality of lithium secondary batteries according to the invention are connected in series or in parallel.

### BRIEF DESCRIPTION OF THE DRAWINGS

FIG. 1 is a longitudinal sectional view schematically showing a lithium secondary battery according to an embodiment of the invention;

FIG. 2 is a schematic view showing the construction of a wound electrode assembly having a flattened shape according to an embodiment of the invention;

FIG. 3 is a graph showing the relationship between the amount of surfactant added and the initial IV resistance;

FIG. 4 is a graph showing the relationship between the amount of surfactant added and the gas retention ratio;

FIG. 5 is a diagram showing the regions into which wound electrode assemblies in the test examples are divided;

FIG. 6A is a graph showing the relationship between the molar concentration of the supporting salt (LiPF₆) and the amount of the gas-forming agent (CHB) in Example 15;

FIG. 6B is a graph showing the relationship between the molar concentration of the supporting salt (LiPF₆) and the amount of the gas-forming agent (CHB) in Example 16; and

FIG. 6C is a graph showing the relationship between the molar concentration of the supporting salt (LiPF₆) and the amount of the gas-forming agent (CHB) in Example 18.

### DESCRIPTION OF THE PREFERRED EMBODIMENTS

Preferred embodiments of the invention are described below. Note that technical matters which are required for carrying out the present invention but are not particularly mentioned in the present specification (e.g., ordinary manufacturing processes for batteries not having the characteristic features of this invention) are matters of design that could be apprehended by a person skilled in the art based on prior art in the field in question. The present invention can be practiced based on the technical details disclosed in the present specification and on common general technical knowledge in the field in question.

The lithium secondary battery disclosed here is provided with a battery case and, housed within the battery case, an electrode assembly having a positive electrode and a negative electrode, and a nonaqueous electrolyte solution that includes a supporting salt, a gas-forming agent and a surfactant.

Hereinafter, constitutional elements are explained one by one.

<<Battery Case>>

The battery case is a container which houses the electrode assembly and the nonaqueous electrolyte solution. The battery case may be made of, for example, a metallic material such as aluminum or steel, or a plastic material such as polyphenylene sulfide or polyimide. Of these, in order to enhance the ability to dissipate heat and to increase energy density, the use of a relatively lightweight metal (e.g., aluminum or an aluminum alloy) is preferred. The shape of the battery case (outside shape of the container) is exemplified by hexahedral shapes (cuboidal and cubic shapes), circular shapes (cylindrical shapes, coin shapes, button shapes), pouch shapes, and other shapes obtained by working and altering the foregoing shapes.

The battery case of the lithium secondary battery disclosed herein is provided with a pressure-actuated current interrupt device (CID) which forcibly interrupts the charging current when the pressure within the battery case reaches or exceeds a predetermined value. Generally, when a lithium secondary battery reaches an overcharged state, a nonaqueous electrolyte solution ingredient (e.g., the nonaqueous solvent or the gas-forming agent) undergoes electrolysis, forming a gas. A pressure-actuated CID interrupts the flow of charging current to the battery when the pressure within the battery case reaches or exceeds a predetermined value due to this gas, and thus stops overcharging from proceeding any further. In addition, owing to the advantageous effects of adding given amounts of a gas-forming agent and a surfactant to the nonaqueous electrolyte solution according to the art disclosed herein, for example, even after rapid charge-discharge cycling, it is possible to oxidatively decompose a large amount of the gas-forming agent immediately upon overcharging of the battery. As a result, this safety mechanism can be more rapidly and appropriately activated.

<<Positive Electrode>>

The positive electrode is not particularly limited, so long as it is provided with a positive electrode active material, although it typically takes a form in which a positive electrode active material layer containing a positive electrode active material has been attached on top of a positive electrode current collector.

A conductive member made of a metal having good conductivity (e.g., aluminum, nickel, titanium) is preferably used as the positive electrode current collector.

The positive electrode active material layer includes at least a positive electrode active material. One or two or more of the various materials known to be suitable for use as the positive electrode active material in lithium secondary batteries may be utilized as the positive electrode active material. Preferred examples include layer-type, spinel-type lithium-transition metal mixed oxide materials (e.g., LiNiO₂, LiCoO₂, LiMn₂O₄, LiFeO₂, LiNi_{0.33}Co_{0.33}Mn_{0.33}O₂, LiNi_{0.5}Mn_{1.5}O₄, LiCrMnO₄) and olivine-type materials (e.g., LiFePO₄). Of these, from the standpoint of heat stability and energy density, preferred use can be made of a lithium-nickel-cobalt manganese mixed oxide which has a layered structure and includes as constituent elements lithium (Li), nickel (Ni), cobalt Co) and manganese (Mn).

In addition to this positive electrode active material, the positive electrode active material layer may include, if necessary, one or two or more materials that can be used as ingredients of the positive electrode active material layer in conventional lithium secondary batteries. Examples of such materials include conductive materials and binders. Examples of conductive materials that may be suitably used include various carbon blacks (e.g., acetylene black, ketjen black), activated carbon, graphite and carbon fibers. Examples of binders that may be suitably used include vinyl halide resins such as polyvinylidene fluoride (PVdF), and polyalkylene oxides such as polyethylene oxide (PEO). In addition, various types of additives (e.g., gas-forming agents, dispersants, thickeners) may also be included, provided doing so does not detract from the advantageous effects of the invention.

It is suitable for the amount of the positive electrode active material as a proportion of the overall positive electrode active material layer to be set to at least about 60 wt % (typically, from 60 to 99 wt %), and generally preferable for the amount to be set to from about 70 wt % to about 95 wt %. When a conductive material is used, the amount of conductive material as a proportion of the overall positive electrode active material layer may be set to, for example, from about 2 wt % to about 20 wt %, and it is generally preferable for this amount to be set to from about 3 wt % to about 10 wt %. When a binder is used, the amount of binder as a proportion of the overall positive electrode active material layer may be set to, for example, from about 0.5 to about 10 wt %, and it is generally preferable for this amount to be set to from about 1 wt % to about 5 wt %.

The mass (weight) of the positive electrode active material layer provided per unit surface area of the positive electrode current collector is preferably set to at least 3 mg/cm² (e.g., at least 5 mg/cm², and typically at least 7 mg/cm²) and not more than 100 mg/cm² (e.g., not more than 70 mg/cm², and typically not more than 50 mg/cm²) per side of the positive electrode current collector. The average thickness per side of the positive electrode active material layer may be set to, for example, at least 20 μm (typically at least 40 μm, and preferably at least 50 μm) and not more than 100 μm (typically not more than 80 μm). The density of the positive electrode active material layer may be set to, for example at least 1 g/cm³ (typically, at least 1.5 g/cm³) and not more than 4 g/cm³ (e.g., not more than 3.5 g/cm³).

By satisfying one or two or more of these preferred properties of the positive electrode active material layer, suitable voids can be retained within the positive electrode active material layer and thorough infiltration by the nonaqueous electrolyte solution can be achieved while at the same time ensuring a high battery capacity. This makes it possible to ensure a broad locus of reaction with the charge carriers, enabling high power characteristics to be exhibited during normal use. Moreover, when overcharging occurs, a large amount of gas-forming agent can rapidly be oxidatively decomposed, enabling, with this as the starting point, the current interrupt device to be appropriately actuated. In addition, conductivity within the positive electrode active material layer can be properly maintained, making it possible to suppress an increase in resistance. Finally, the mechanical strength (shape retention) of the positive electrode active material layer can be suitably ensured, enabling good cycle characteristics to be achieved.

In the art disclosed herein, a nonaqueous electrolyte solution containing a supporting salt, a gas-forming agent and a surfactant is impregnated into the positive electrode active material layer (typically, into pores of the positive electrode active material layer). Moreover, this art is characterized in that, even after rapid charge-discharge cycling, for example, the amount of gas-forming agent present is kept substantially uniform in the direction of impregnation by the nonaqueous electrolyte solution. To illustrate, let us assume that, in the linear direction extending from a given first edge portion of the positive electrode active material layer (and typically passing through the center portion) to a second edge portion thereof, the positive electrode active material layer is divided into a plurality of equally spaced regions (preferably from three to seven regions, such as five regions), and the amount of gas-forming agent included in each of these regions is determined. At this time, the ratio M2/M1 of the largest measured value M2 to the smallest measured value M1 may become less than 2 (typically, from 0.9 to 1.9, such as from 1 to 1.5). By thus keeping the amount of gas-forming agent present within the positive electrode active material layer uniform even after rapid charge-discharge cycling, for example, the gas-forming agent can rapidly be oxidatively decomposed when overcharging occurs. As a result, a large amount of gas can be generated at an earlier stage of overcharging, enabling the current interrupt device to be rapidly actuated.

<<Negative Electrode>>

The negative electrode is not particularly limited, provided it has a negative electrode active material, although it typically takes a form in which a negative electrode active material layer containing a negative electrode active material has been attached on top of a negative electrode current collector.

A conductive member made of a metal having good conductivity (e.g., copper, nickel, titanium, stainless steel) is preferably used as the negative electrode current collector.

The negative electrode active material layer includes at least a negative electrode active material. One or two or more of the various materials known to be capable of use as the negative electrode active material in lithium secondary batteries may be utilized as the negative electrode active material. Preferred examples include various carbon materials, such as graphite, non-graphitizable carbon (hard carbon), graphitizable carbon (soft carbon), carbon nanotubes, and materials having a structure in which these are combined. Of the above, from the standpoint of energy density, the use of a graphite-based material is preferred.

In addition to this negative electrode active material, the negative electrode active material layer may include, if necessary, one or two or more materials that can be used as ingredients of the negative electrode active material layer in conventional lithium secondary batteries. Examples of such materials include binders and various types of additives. Examples of binders that may be suitably used include styrene-butadiene rubber (SBR), polyvinylidene fluoride (PVdF) and polytetrafluoroethylene (PTFE). In addition, suitable use can also be made of various additives, such as thickeners, dispersants and conductive materials. Examples of thickeners that may be suitably used include carboxymethyl cellulose (CMC) and methyl cellulose (MC).

It is suitable for the amount of the negative electrode active material as a proportion of the overall negative electrode active material layer to be set to at least about 50 wt %, and generally preferable to have this be from 90 to 99 wt % (e.g., from 95 to 99 wt %). When a binder is used, the amount of binder as a proportion of the overall negative electrode active material layer may be set to, for example, from about 1 wt % to about 10 wt %, and it is generally preferable for this amount to be set to from about 1 wt % to about 5 wt %. When a thickener is used, the amount of thickener as a proportion of the overall negative electrode active material layer may be set to, for example, from about 1 wt % to about 10 wt %, and it is generally preferable for this amount to be set to from about 1 wt % to about 5 wt %.

As with the positive electrode active material layer, the interior of the negative electrode active material layer (typically, the interior of pores within the negative electrode active material layer) are impregnated with the nonaqueous electrolyte solution containing a supporting salt, a gas-forming agent and a surfactant. Even after rapid charge-discharge cycling, for example, generally, a lack of uniformity in the supporting salt concentration has a tendency to readily arise in the direction of impregnation by the nonaqueous electrolyte solution. To illustrate, let us assume that, in the linear direction extending from a given first edge portion of the negative electrode active material layer (and typically passing through the center portion) to a second edge portion thereof, the negative electrode active material layer is divided into a plurality of equally spaced regions (preferably from three to seven regions, such as five regions), and the amount of gas-forming agent included in each of these regions is determined. At this time, the ratio Q2/Q1 of the highest measured concentration Q2 to the lowest measured concentration Q1 may become 2 or more (typically, from 2 to 10, such as from 2.5 to 5). In such cases, current interrupt device actuation would be delayed in conventional batteries. However, in the art disclosed herein, the ability to actuate the current interrupt device can be enhanced, enabling a high reliability to be achieved.

<<Nonaqueous Electrolyte Solution>>

At the time of battery construction, the nonaqueous electrolyte solution of the lithium secondary battery disclosed herein includes, within a nonaqueous solvent, at least: (1) a supporting salt, (2) a gas-forming agent, and (3) a surfactant. The nonaqueous electrolyte solution exhibits a liquid state at normal temperatures (e.g., 25° C.), and preferably always exhibits a liquid state in the service environment of the battery (e.g., in −30° C. to 60° C. temperature environments).

Any of various organic solvents commonly used in the nonaqueous electrolyte solutions of lithium secondary batteries (e.g., carbonates, ethers, esters, nitriles, sulfones, lactones) may be used as the nonaqueous solvent. Illustrative examples include ethylene carbonate (EC), propylene carbonate (PC), diethyl carbonate (DEC), dimethyl carbonate (DMC) and ethyl methyl carbonate (EMC). Such nonaqueous solvents may be used singly or two or more may be used in suitable combinations.

In a preferred embodiment, a high-dielectric-constant solvent and a low-viscosity solvent are used in admixture. By using such a mixed solvent, the electrical conductivity is high and use of the battery in a broad temperature range becomes possible. An example of a high-dielectric-constant solvent is EC, and examples of low-viscosity solvents include DMC and EMC. Preferred use can be made of, for example, a nonaqueous solvent which includes one or two or more carbonates, with the combined volume of these carbonates accounting for at least 60 vol % (more preferably at least 75 vol %, and even more preferably at least 90 vol %; this may even be practically 100 vol %) of the volume of the overall nonaqueous solvent.

(1) Supporting Salt

A supporting salt similar to those employed in conventional lithium secondary batteries may be suitably selected for use here, so long as it includes a charge carrier (lithium ions). Illustrative examples include LiPF₆, LiBF₄, LiClO₄, LiAsF₆, Li(CF₃SO₂)₂N and LiCF₃SO₃. Such supporting salts may be used singly or two or more may be used in combination. The concentration of the supporting salt, based on the overall nonaqueous electrolyte solution, is preferably set to from 0.7 to 1.3 mol/L.

(2) Gas-Forming Agent

Any compound that is capable of decomposing and generating a gas when a given battery voltage has been exceeded (i.e., a compound which has an oxidation potential (vs. Li/Li⁺) equal to or higher than the positive electrode cutoff potential during charging (vs. Li/Li⁺), and which can decompose and generate a gas when the battery exceeds this potential and assumes an overcharged state) may be used without particular limitation as the gas-forming agent. Illustrative examples include aromatic compounds such as biphenyl compounds, alkylbiphenyl compounds, cycloalkylbenzene compounds, alkylbenzene compounds, organophosphorus compounds, fluorine-substituted aromatic compounds, carbonate compounds, cyclic carbamate compounds and alicyclic hydrocarbons.

For example, in batteries for which the positive electrode cutoff potential during charging (vs. Li/Li⁺) is set to about 4.0 to 4.2 V, preferred use can be made of biphenyl (oxidation potential: 4.5 V (vs. Li/Li⁺) or cyclohexylbenzene (oxidation potential: 4.6 V (vs. Li/Li⁺). Because these gas-forming agents have an oxidation potential close to the cutoff potential during charging, at an early stage of overcharging, oxidative decomposition arises at the positive electrode, enabling a gas (typically, hydrogen gas) to rapidly form. Because these compounds readily form a conjugated system and electron transfer is easy, they are able to generate a large amount of gas. Accordingly, the current interrupt device be rapidly and appropriately activated, enabling the battery reliability to be increased.

To ensure a sufficient amount of gas to activate the current interrupt device, it is critical that the amount of gas-forming agent included in the nonaqueous electrolyte solution be at least 2 wt % (e.g., 3 wt % or more), based on the overall nonaqueous electrolyte solution (100%). By setting this amount in the above range, a sufficient amount of gas can be formed during overcharging, and the current interrupt device can be properly activated. However, because the gas-forming agent may become an ingredient that resists the battery reactions, when added in excess, it may lower the energy density and power characteristics of the battery. From this standpoint, it is preferable to set the amount of gas-forming agent to not more than 6 wt % (and typically not more than 5 wt %, such as 4 wt % or less). Within this range, the resistance can be suppressed, and high battery characteristics can be exhibited during normal use.

(3) Surfactant

A polyethylene glycol fatty acid ester, which is an ester-type nonionic surfactant, is used as the surfactant. The polyethylene glycol fatty acid ester is not particularly limited, provided it is an ester obtained from polyethylene glycol and a fatty acid ester. The polyethylene glycol is preferably one having a degree of polymerization of from 2 to 20 (typically from 2 to 10, such as from 2 to 5). The fatty acid from which the ester is made is preferably a saturated or unsaturated fatty acid that is linear or branched and has from 10 to 30 carbon atoms. Illustrative examples of polyethylene glycol fatty acid esters obtained from such polyethylene glycols and fatty acids include monoesters such as polyethylene glycol monolaurate, polyethylene glycol monostearate and polyethylene glycol monooleate, and diesters such as polyethylene glycol dilaurate, polyethylene glycol distearate and polyethylene glycol dioleate. Of these, from the standpoint of solubility in the nonaqueous electrolyte solution and availability, the use of polyethylene glycol distearate is preferred. By including this ingredient in a nonaqueous electrolyte solution, even in cases where a lack of uniformity in the supporting salt concentration arises within the active material layers, phase separation between the nonaqueous electrolyte solution and the gas-forming agent can be suppressed. Moreover, the wettability between the active material layer and the nonaqueous electrolyte solution can be increased. As a result, the gas-forming agent can be uniformly distributed within the positive electrode, and a lithium secondary battery having a large overcharge tolerance can be achieved.

To impart good wettability to the positive electrode active material layer, it is critical for the amount of surfactant included in the nonaqueous electrolyte solution to be at least 1 wt % (e.g., 1.5 wt % or more), based on the overall nonaqueous electrolyte solution (100 wt %). By setting the amount of surfactant in this range, the advantageous effects of the invention can be achieved to a high degree. However, because the surfactant is capable of becoming an ingredient that resists the battery reactions, when added in excess, it may lower the energy density and power characteristics of the battery. From this standpoint, the amount of surfactant is preferably set to not more than 3.5 wt % (and typically not more than 3 wt %, such as 2.5 wt % or less). Within this range, the resistance can be suppressed, and high battery characteristics can be exhibited during normal use.

In the art disclosed herein, it suffices for the nonaqueous electrolyte solution to include (2) the gas-forming agent and (3) the surfactant in at least the cell assembly state (the state prior to charging treatment). For example, ingredients (2) and/or (3) need not necessarily remain in the nonaqueous electrolyte solution after charging and discharging have been repeated a plurality of times.

In addition to above ingredients (1) to (3), the nonaqueous electrolyte solution may include, if necessary, various other additives, to the extent that doing so does not markedly detract from the advantageous effects of the invention. Examples of such additives include film-forming agents such as vinylene carbonate (VC), vinyl ethylene carbonate (VEC), fluoroethylene carbonate (FEC) and lithium bis(oxalato)borate (Li[B(C₂O₄)₂], and also dispersants and thickeners.

Although not intended to be particularly limitative, lithium secondary batteries in a form obtained by housing a wound electrode assembly having a flattened shape and a nonaqueous electrolyte solution in a battery case having a flattened cuboidal shape are described below as embodiments of the invention. Also, in the diagrams described below, members or features having like functions are designated by like symbols, and repeated explanations may be omitted or simplified. Relative dimensions (length, width, thickness, etc.) of features shown in the diagrams may not be true to scale.

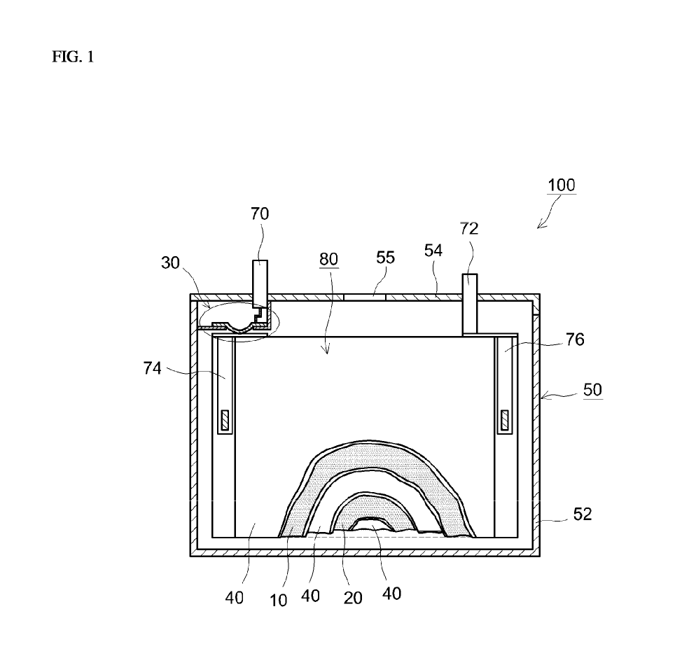

FIG. 1 is a longitudinal sectional view which schematically shows the structure of a lithium secondary battery 100. This lithium secondary battery 100 has a construction in which an electrode assembly (wound electrode assembly) 80 in a form obtained by flatly winding an elongated positive electrode sheet 10 and an elongated negative electrode sheet 20, with an elongated separator sheet 40 being provided therebetween, and a nonaqueous electrolyte solution (not shown) are housed within an electrode case 50 having a flattened box-like shape.

The battery case 50 includes a battery case body 52 that is open on a top end and has a flattened cuboidal shape (box shape), and a lid 54 which closes the opening in the case body 52. A positive electrode terminal 70 for external connection which is electrically connected to the positive electrode of the wound electrode assembly 80 and a negative electrode terminal 72 which is electrically connected to the negative electrode of the wound electrode assembly 80 are provided on the top side (i.e., the lid 54) of the battery case 50. The lid 54 is equipped with a safety valve 55 for discharging to the exterior of the battery case 50 gases that have formed at the interior of the case 50.

In addition, at the interior of the battery case 50, a current interrupt device 30 which actuates when the pressure within the battery case rises is provided between the positive electrode terminal 70 fastened to the lid 54 and the wound electrode assembly 80. The current interrupt device 30 is configured so as to interrupt the charging current by cutting the conductive path from at least one electrode terminal (i.e., positive electrode terminal 70 and/or negative electrode terminal 72) to the wound electrode assembly 80 when a rise in the pressure within the battery case 50 has occurred. In this embodiment, the current interrupt device 30 is configured so as to cut the conductive path from the positive electrode terminal 70 to the wound electrode assembly 80 when a rise in the pressure within the battery case 50 has occurred.

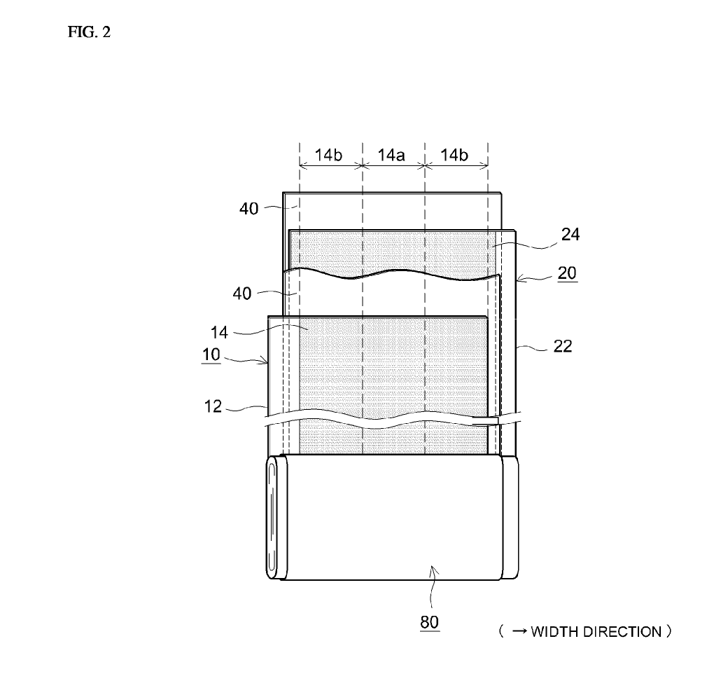

The wound electrode assembly 80 having a flattened shape and the nonaqueous electrolyte solution (not shown) are housed at the interior of the battery case 50. FIG. 2 is a schematic diagram showing the structure of the wound electrode assembly 80 having a flattened shape. The wound electrode assembly 80 is constructed of an elongated positive electrode (positive electrode sheet) 10 and an elongated negative electrode (negative electrode sheet) 20. The positive electrode sheet 10 includes an elongated positive electrode current collector 12, and a positive electrode active material layer 14 formed along the lengthwise direction on at least one surface thereof (typically on both surfaces). The negative electrode sheet 20 includes an elongated negative electrode current collector 22, and a negative electrode active material layer 24 formed along the lengthwise direction on at least one surface thereof (typically on both surfaces). In addition, two elongated separator sheets 40 are disposed between the positive electrode active material layer 14 and the negative electrode active material layer 24 as dielectric layers to prevent direct contact therebetween.

The separator sheet 40 may be, for example, a porous sheet made of a resin such as polyethylene (PE), polypropylene (PP), polyester, cellulose or polyamide, or may be a nonwoven fabric.

In the width direction, defined as the direction along a winding axis of the wound electrode assembly 80 from a first edge portion of the wound electrode assembly 80 toward a second edge portion thereof, there is formed at a center portion thereof a wound core region where the positive electrode active material layer 14 formed on the surface of the positive electrode current collector 12 and the negative electrode active material layer 24 formed on the surface of the negative electrode current collector 22 are arranged over one another in a tightly stacked manner. Also, a positive electrode active material layer-free region of the positive electrode sheet 10 and a negative electrode active material layer-free region of the negative electrode sheet 20 respectively protrude outside of the wound core region at either edge portion in the winding axis direction of the wound electrode assembly 80. In addition, a positive electrode current-collecting plate 74 is provided at the protruding region on the positive electrode side (i.e., the positive electrode active material layer-free region) and a negative electrode current-collecting plate 76 is provided at the protruding region on the negative electrode side (i.e., the negative electrode active material layer-free region), and these are electrically connected with, respectively, the positive electrode terminal 70 (FIG. 1) and the negative electrode terminal 72 (FIG. 1).

At the positive electrode 10 (typically, the positive electrode active material layer 14) of the lithium secondary battery disclosed herein, compared with conventional products, there is little lack of uniformity in the presence of the gas-forming agent in the direction of impregnation of the nonaqueous electrolyte solution. For example, even after rapid charge-discharge cycling, letting positive electrode active material layer 14 be segmented (equally divided) into three regions in the direction of impregnation of the nonaqueous electrolyte solution (the width direction indicated by the arrow in FIG. 2), it is possible for the ratio Mb/Ma of the amount of gas-forming agent Mb included in the edge portions 14b to the amount of gas-forming agent Ma included in the center portion 14a to be less than 2 (typically, from 0.9 to 1.9, such as from 1 to 1.5). This enables an excellent overcharge tolerance to be achieved.

Also, in a preferred embodiment, by providing, in the interior flattened portion of the positive electrode active material layer 14 which makes up part of the wound electrode assembly 80 having a flattened shape and from which at least the outermost periphery of the positive electrode active material layer 14 has been excluded, a plurality of regions at equal intervals on a straight line in the direction of impregnation (width direction) of the nonaqueous electrolyte solution and determining the amount of gas-forming agent present in each of these regions, the ratio M2/M1 of the largest measured value M2 to the smallest measured value M1 may be less than 2 (typically from 0.9 to 1.9, such as from 1 to 1.5). In a positive electrode active material layer in which the gas-forming agent is uniformly included in this way, even when a distribution (lack of uniformity) arises in the supporting salt concentration, the gas-forming agent can immediately be oxidatively decomposed when overcharging occurs, enabling a large amount of gas to be generated. Therefore, compared with conventional products, the overcharge tolerance resistance can be enhanced.

Although the battery disclosed herein can be used in various applications, it is characterized by properly exhibiting the advantageous effects of gas-forming agent addition and, even after rapid charge-discharge cycling, having an excellent overcharge tolerance. Moreover, in a preferred embodiment, the battery is characterized in that the battery properties during normal use (e.g., energy density and power density) and the overcharge tolerance can both be achieved at a high level. By taking full advantage of these characteristics, the battery of the invention is well-adapted for use as, for example, an on-board power source for vehicle propulsion. The type of vehicle is not particularly limited and includes plug-in hybrid vehicles (PHV), hybrid vehicles (HV), electric vehicles (EV), electric trucks, electric motorcycles, power-assisted bicycles, electric-powered wheelchairs and electric railroads.

Examples of the invention are described below, although these examples are not intended to limit the invention in any way.

[Building the Lithium Secondary Battery]

First, a positive electrode active material slurry was prepared by charging a kneader with LiNi_{0.33}Mn_{0.33}Co_{0.33}O₂ (LNCM) as the positive electrode active material, acetylene black (AB) as the conductive material and polyvinylidene fluoride (PVdF) as the binder in a weight ratio among these materials of LNCM:AB:PVdF=90:8:2, and kneading the materials while adjusting the viscosity with N-methylpyrrolidone (NMP). This slurry was applied to both sides of a 15 μm thick aluminum foil (positive electrode current collector) to a weight per side of 23.3 mg/cm², then dried and pressed, thereby producing a positive electrode sheet having a positive electrode active material layer on each side of a positive electrode current collector (total thickness, 170 μm; layer density, 3 g/cm³).

Next, a negative electrode active material slurry was prepared by charging a kneader with natural graphite (C) as the negative electrode active material, styrene-butadiene rubber (SBR) as the binder, and carboxymethyl cellulose (CMC) as the dispersant in a weight ratio among these materials of C:SBR:CMC=98:1:1, and kneading the materials while adjusting the viscosity with deionized water. This slurry was applied to both sides of a 10 μm thick strip of copper foil (negative electrode current collector), then dried and pressed, thereby producing a negative electrode sheet having a negative electrode active material layer on each side of a negative electrode current collector.

The positive electrode sheet and negative electrode sheet produced above were stacked together with two separator sheets (each of the separator sheets used here having a trilayer construction wherein a layer of polypropylene (PP) is laminated on either side of a layer of polyethylene (PE)) and wound, then laterally pressed and squashed, thereby fabricating a wound electrode assembly having a flattened shape.

The wound electrode assembly thus fabricated was placed in a laminate battery case, and the opening was heat-welded. A nonaqueous electrolyte solution was prepared by dissolving LiPF₆ as the supporting salt to a concentration of 1.1 mol/L in a mixed solvent of ethylene carbonate (EC), dimethyl carbonate (DMC) and ethyl methyl carbonate (EMC) having the volumetric ratio EC:DMC:EMC=30:40:30, and additionally dissolving therein cyclohexylbenzene (CHB) as the gas-forming agent and polyethylene glycol distearate as the surfactant in the proportions shown in Table 1. In this way, lithium secondary batteries (Examples 1 to 35) were built in which only the amount of gas-forming agent and/or the amount of surfactant differed.

TABLE 1

| | Gas-forming | | Initial IV | Gas retention |
|---|---|---|---|---|
| | agent | Surfactant | resistance | ratio (before |
| | (wt %) | (wt %) | (relative value) | cycle/after cycle) |
| EX 1 | 1 | 0 | 1 | 0.5 |
| EX 2 | | 0.5 | 1.003 | 0.6 |
| EX 3 | | 1 | 1.007 | 0.62 |
| EX 4 | | 2 | 1.01 | 0.62 |
| EX 5 | | 3 | 1.03 | 0.61 |
| EX 6 | | 4 | 1.07 | 0.62 |
| EX 7 | | 5 | 1.29 | 0.62 |
| EX 8 | 2 | 0 | 1 | 0.7 |
| EX 9 | | 0.5 | 1.007 | 0.71 |
| EX 10 | | 1 | 1.04 | 0.95 |
| EX 11 | | 2 | 1.06 | 0.93 |
| EX 12 | | 3 | 1.07 | 0.94 |
| EX 13 | | 4 | 1.18 | 0.95 |
| EX 14 | | 5 | 1.29 | 0.97 |
| EX 15 | 3.5 | 0 | 1 | 0.7 |
| EX 16 | | 0.5 | 1.02 | 0.75 |
| EX 17 | | 1 | 1.07 | 0.94 |
| EX 18 | | 2 | 1.08 | 1.01 |
| EX 19 | | 3 | 1.09 | 0.95 |
| EX 20 | | 4 | 1.21 | 0.98 |
| EX 21 | | 5 | 1.35 | 0.97 |
| EX 22 | 5 | 0 | 1 | 0.7 |
| EX 23 | | 0.5 | 1.01 | 0.72 |
| EX 24 | | 1 | 1.06 | 0.93 |
| EX 25 | | 2 | 1.08 | 1.01 |
| EX 26 | | 3 | 1.09 | 1 |
| EX 27 | | 4 | 1.19 | 0.99 |
| EX 28 | | 5 | 1.31 | 0.98 |
| EX 29 | 7 | 0 | 1.1 | 0.71 |
| EX 30 | | 0.5 | 1.14 | 0.73 |
| EX 31 | | 1 | 1.19 | 0.92 |
| EX 32 | | 2 | 1.20 | 1.05 |
| EX 33 | | 3 | 1.24 | 1.03 |
| EX 34 | | 4 | 1.28 | 1.01 |
| EX 35 | | 5 | 1.32 | 1.02 |

Initial charging treatment in a 25° C. environment was carried out on the batteries that were built. This consisted of carrying out constant-current (CC) charging at a charge rate of 1 C until the voltage between the positive and negative electrode terminals reaches 4.1 V, then carrying out constant-voltage (CV) charging until the current value becomes 0.02 C.

[Measurement of Initial IV Resistance]

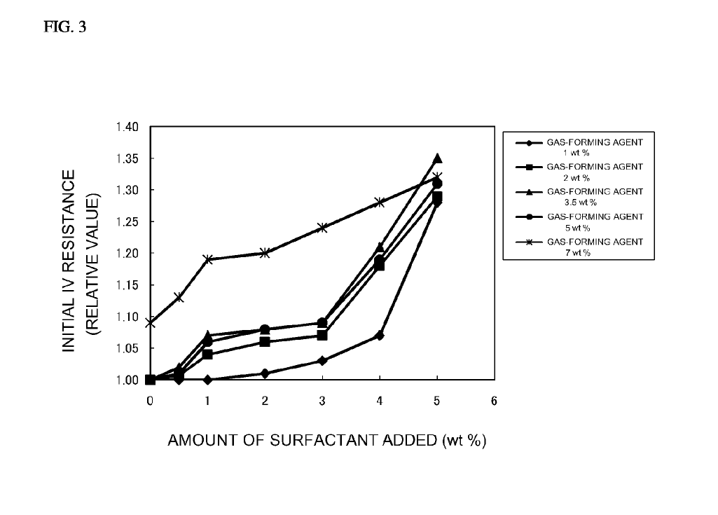

The lithium secondary battery following initial charging treatment was adjusted to a state of charge (SOC) of 30%, following which the battery was discharged for 10 seconds in a −30° C. environment at a rate of 5 C and the IV resistance was calculated from the voltage drop during this period. The results are shown in the corresponding column of Table 1 and in FIG. 3. Table 1 presents relative values based on a relative value of 1 for the initial IV resistance of the battery in Example 8.

[Measurement of Amount of Gas Generated]

The lithium secondary battery following initial charging treatment was adjusted to a SOC of 100%, following which the battery was constant-current charged to a SOC of 140% (that is, to an overcharged state), and the amount of gas generated at a SOC of 140% was measured by Archimedes' method.

In addition, other lithium secondary batteries that were separately fabricated were subjected, following initial charging treatment, to 1,000 charge-discharge cycles, each cycle having the pattern indicated by (1) and (2) below:

(1) CC charging to 4.1 V at a constant current of 10 C, followed by 5 minutes at rest;
(2) CC discharging to 3.0 V at a constant current of 10 C, followed by 5 minutes at rest.

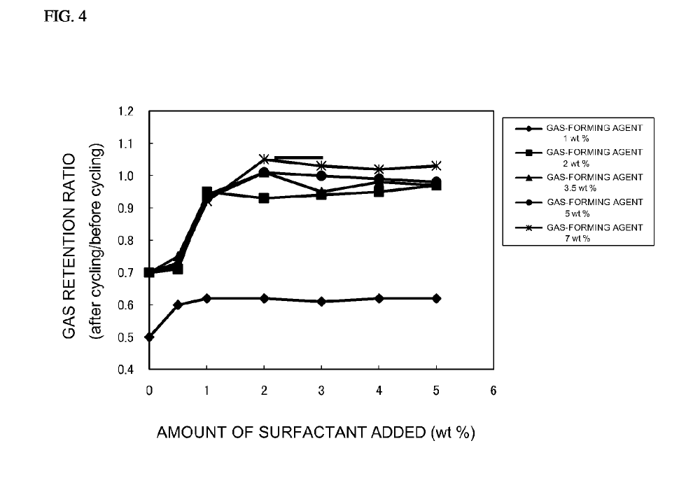

Following test completion, the amount of gas generated after high-rate cycling was measured in the same way as described above. The gas retention ratio (after cycling/before cycling) was then calculated by dividing the amount of gas generated following high-rate cycling by the amount of gas generated before high-rate cycling. The results are shown in the corresponding column of Table 1 and in FIG. 4.

As shown in Table 1 and FIG. 4, in Examples 1 to 7 in which the amount of gas-forming agent included was set to 1 wt %, the amount of gas generated after high-rate cycling decreased. Similarly, even in Examples 8, 9, 15, 16, 22, 23, 29 and 30 in which the amount of gas-forming agent included was set to less than 1 wt %, the amount of gas generated after high-rate cycling decreased. By contrast, in cases where the amount of gas-forming agent included was set to 2 wt % or more and in cases where the amount of surfactant included was set to 1 wt % or more, the gas retention ratio had a high value of 0.9 or more (e.g., 0.95 or more, and even 1 or more). The reason is thought to be that, by including polyethylene glycol distearate in the nonaqueous electrolyte solution in an amount of 1 wt % or more, it was possible to suppress phase separation between the nonaqueous electrolyte solution and the gas-forming agent, enabling the gas-forming agent to be uniformly distributed within the positive electrode (within the positive electrode active material layer). These results show the technical significance of the invention.

As shown in Table 1 and FIG. 3, the initial IV resistance tends to become higher as the amount of gas-forming agent and/or the amount of surfactant rises. Hence, it was found that, so long as the desirable effects of the invention are exhibited, the amounts in which these ingredients are included should be kept low.

For example, when the amount of gas-forming agent included is 7 wt % or more, a marked increase in resistance occurs. It thus became clear that, by setting the amount of gas-forming agent included to 6 wt % or less (preferably, 5 wt % or less), the initial IV resistance can be kept low and it is possible to achieve both excellent battery characteristics during normal use and an excellent overcharge tolerance. Likewise, when the amount of surfactant included is 4 wt % or more, a marked increase in resistance occurs. It thus became clear that, by setting the amount of surfactant included to 3.5 wt % or less (preferably, 3 wt % or less, and more preferably 2 wt % or less), the initial IV resistance can be kept low and it is possible to achieve both excellent battery characteristics during normal use and an excellent overcharge tolerance.

[Measurement of Amount of CHB in Positive Electrode]

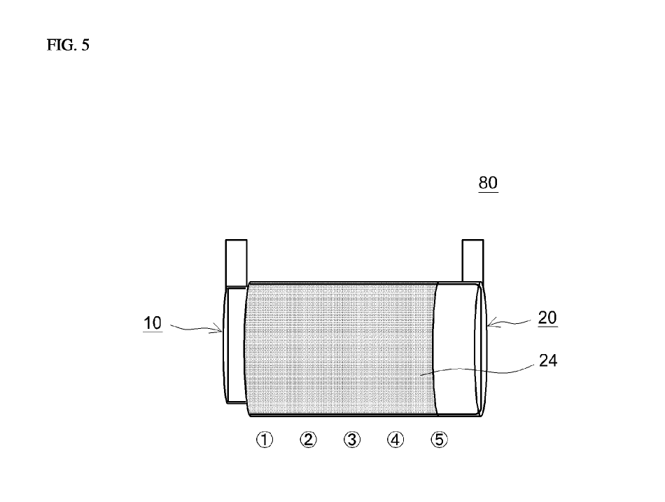

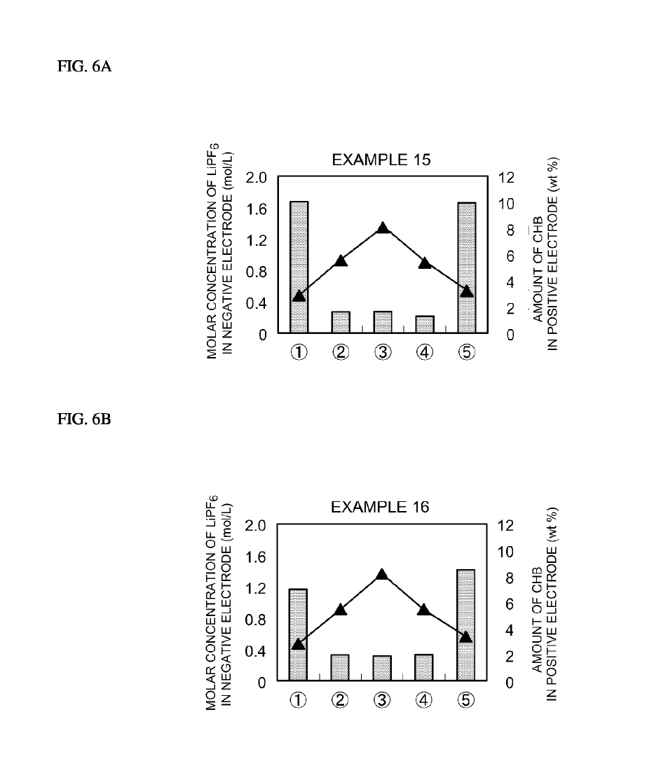

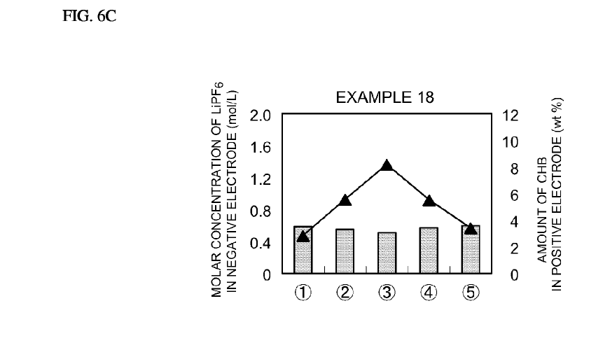

To verify the above conjectures, the distribution of gas-forming agent within the positive electrode was checked. First, the lithium secondary batteries in Examples 15, 16 and 18 were again fabricated and the same procedure was carried out up until the high-rate cycling test, after which each battery was disassembled and the electrode assembly was removed. Next, as shown in FIG. 5, the wound electrode assembly was divided equally by five in the width direction (direction of impregnation by the nonaqueous electrolyte solution), thereby establishing five regions. Measurement specimens of a given size were then cut out of the positive electrode in the respective regions, and the amount of CHB present in each of the regions (1) to (5) was measured by the GC technique mentioned above. Next, letting the total amount of CHB included in the nonaqueous electrolyte solution be 100 wt %, the amount of CHB (wt %) present in each of these regions was calculated. The results are shown in FIGS. 6A to 6C.

[Measurement of Supporting Salt Concentration in Negative Electrode]

Measurement specimens of a given size were cut out of the negative electrode in the five regions described above, and the amounts of the supporting salt (PF₆⁻ (mol/g)) and solvent (here, EC (mol/g)) present in each of the regions (1) to (5) were respectively measured by the NMR technique mentioned above. The volume of mixed solvent was calculated based on the measured amounts of EC obtained by NMR and the volume ratio of the mixed solvent used to build the battery. Next, the molar concentrations (mol/L) of the supporting salt included in each region were calculated by dividing the measured amount of the supporting salt obtained by NMR for that region by the volume of the mixed solvent. The results are shown in FIG. 6A to 6C.

As shown in FIG. 6, in all of the examples, the supporting salt concentration was highest at the center portion of the negative electrode in the width direction, and was lowest at the edge portions in the width direction.

In Examples 15 (FIG. 6A) and 16 (FIG. 6B) in which the amount of surfactant included was set to less than 1% (based on 100 wt % for the nonaqueous electrolyte solution), the amount of surfactant present in the width direction of the positive electrode lacked uniformity; that is, the amount of surfactant present was low at the center portion in the width direction, and was high at the edge portions in the width direction. However, in Example 18 in which the amount of surfactant included was set to 2% (based on 100 wt % for the nonaqueous electrolyte solution), the surfactant was substantially uniformly present over the width direction of the positive electrode. These results demonstrated that in Example 18, as anticipated above, a lack of uniformity in the gas-forming agent (here, CHB) vanished.

The invention has been described in detail above, although it should be noted that these embodiments and examples are provided only by way of illustration, many variations and modifications to these embodiments and examples being encompassed by the invention disclosed herein.

What is claimed is:

1. A lithium secondary battery comprising a battery case housing an electrode assembly having a positive electrode and a negative electrode, and also housing a nonaqueous electrolyte solution including a supporting salt, wherein
the nonaqueous electrolyte solution contains, in addition to the supporting salt, at least 2 wt % of a gas-forming agent that decomposes to form a gas when the battery reaches an overcharged state, and, as a surfactant, at least 1 wt % of a polyethylene glycol fatty acid ester, and
the battery case is equipped with a current interrupt device that is actuated by a rise in pressure within the battery case.

2. The lithium secondary battery according to claim 1, wherein the content of the polyethylene glycol fatty acid ester is not more than 3 wt %.

3. The lithium secondary battery according to claim 1, wherein the content of the gas-forming agent is not more than 5 wt %.

4. The lithium secondary battery according to claim 1, wherein the polyethylene glycol fatty acid ester is polyethylene glycol distearate.

5. The lithium secondary battery according to claim 1, wherein
the electrode assembly is a wound electrode assembly comprising a positive electrode, a negative electrode and a separator, each having an elongated shape, that have been placed over one another and wound together in a lengthwise direction thereof,
in a width direction defined as a direction along a winding axis of the wound electrode assembly from a first edge portion of the wound electrode assembly toward a second edge portion thereof, the ratio Mb/Ma of the amount (Mb) of the gas-forming agent included at an edge portion of the positive electrode to the amount (Ma) of the gas-forming agent included at a center portion of the positive electrode is less than 2, and
in the width direction, the ratio Qb/Qa of the amount per unit volume (Qb) of the supporting salt included at an edge portion of the negative electrode to the amount per unit volume (Qa) of the supporting salt included at a center portion of the negative electrode is 2 or more.
